(19) United States
(12) Patent Application Publication
(10) Pub. No.: US 2016/0198255 A1
(43) Pub. Date: Jul. 7, 2016

(54) Internal-External Speaker Headphones that Transform Into a Portable Sound System

(71) Applicant: HEADBOX, LLC DBA BOOMPHONES, KNOXVILLE, TN (US)

(72) Inventors: Michael Zachary Camello, Knoxville, TN (US); Ira Laurie Strasberg, Knoxville, TN (US); Ohad Einbinder, Knoxville, TN (US)

(73) Assignee: HEADBOX, LLC DBA BOOMPHONES, KNOXVILLE, TN (US)

(21) Appl. No.: 15/066,865

(22) Filed: Mar. 10, 2016

Related U.S. Application Data
(63) Continuation of application No. 14/448,025, filed on Jul. 31, 2014, now abandoned.
Application No. 14/448,025 is a continuation-in-part of application No. 14/105,522, filed on Dec. 13, 2013, now abandoned.
(60) Provisional application No. 61/736,900, filed on Dec. 13, 2012.

(51) Int. Cl. H04R 1/10; H04R 1/32

(52) U.S. Cl. CPC H04R 1/1091; H04R 1/1066; H04R 1/1041; H04R 1/1025; H04R 1/323; H04R 2420/09; H04R 2430/01; H04R 2201/028

(57) ABSTRACT

Combination headphones having internal speakers and external speakers. A controller allows for audio to be emitted from the internal speakers, the external speaker, or both. The headphones have earpieces detachably connected at opposing ends of a headpiece in such a way that the earpieces may be collapsed toward the headpiece and stacked onto each other.

### FIELD OF THE INVENTION

The present invention relates generally to portable sound delivery systems, and in a specific though non-limiting embodiment, to a set of headphones equipped with both interior and exterior speakers, each of which are individually or collectively controllable, wherein, in certain embodiments, the headset or portions thereof collapse or release in such a manner that they can be integrally docked as part of a portable sound system such as a “boom box” or the like.

### BACKGROUND

Headphones and ear buds may provide good sound quality when worn in or over ears; however, the music and/or sound played through headphones and/or ear buds generally cannot be shared with others in the surroundings. Despite a desire to share audio, an unamplified audio signal played through typical headphones or ear buds does not provide a good listening experience. In order to play an audio signal with sufficient volume and quality to be shared with others, an amplified signal and speakers are generally required.

Attempts to combine headphones and amplified speakers typically have led to combined headphones having interior speakers and exterior speakers. While the external speakers permit audio signals to be played with sufficient quality and volume to be shared with others, configurations of the combined headphones do not provide for the speakers to be combined or otherwise be turned into a portable sound system. Combination headphones also do not permit use as a phone audio connection/microphone.

Accordingly, there is need for improved headphones capable of emit unamplified audio sounds to internal headphone speakers and emitting audio signals, which may be amplified, to the surroundings through external speakers while being configured to be combined and serve as a portable sound system.

### SUMMARY

In an exemplary embodiment of the present invention, an audio system, is provided, including: a headpiece; a pair of earpieces each earpiece having at least one internal speaker on one side and at least one external speaker on an opposite side; at least one audio signal input configured to receive an audio signal; and a sound distribution and control means. The sound distribution and control means is configured to direct transmission of the audio signal to at least one of the internal speakers and the external speakers. The earpieces are detachably connected to the headpiece. The connection of the earpieces to the headpieces allows for the earpieces to be collapsed inward toward the headpiece and such that the earpieces can be stacked upon each other.

The audio system may include a power switch and a battery. The power switch may activate the battery. The battery may be rechargeable. The audio system may include a port. The port may be a USB port. The audio system may include at least one LED lighting system. The at least one LED lighting system may be configured to indicate different modes of the audio system. The audio system may include an amplification means configured to amplify an audio signal to the external speakers.

The audio system may include an audio input for each earpiece. The audio system may include at least one volume control. The audio system may include at least one 4-pin jack. The audio system may include a phone controller.

### DESCRIPTION OF DRAWINGS

FIG. 1 is top view of headphones according to an exemplary embodiment of the present invention.

FIG. 1A is a front view of the headphones shown in FIG. 1.

FIG. 1B is an isometric view of the headphones shown in FIG. 1.

FIG. 1C is a side view of the headphones shown in FIG. 1.

FIG. 1D is a side isometric view of the headphones shown in FIG. 1.

FIG. 2 is side isometric view of headphones according to an exemplary embodiment of the present invention.

FIG. 2A is a front view of an earpiece from of the headphones shown in FIG. 2.

FIG. 2B is a side view of the earpiece shown in FIG. 2A.

FIG. 3 is a front view of headphones according to an exemplary embodiment of the present invention.

FIG. 3A is a side view of the headphones shown in FIG. 3.

FIG. 4 is a side isometric of headphones according to an exemplary embodiment of the present invention.

FIG. 5 is a front view of headphones according to an exemplary embodiment of the present invention.

FIG. 5A is a side view of the headphones shown in FIG. 5.

FIG. 6 is a side view of headphones according to an exemplary embodiment of the present invention.

FIG. 7 is a side view of headphones according to an exemplary embodiment of the present invention.

FIG. 8 is a front view of headphones according to an exemplary embodiment of the present invention.

FIG. 8A is a side view of the headphones shown in FIG. 8.

FIG. 9 is a front view of a phone controller according to an exemplary embodiment of the present invention.

FIG. 9A is a side view of the phone controller shown in FIG. 9.

FIG. 9B is an isometric view of the phone controller shown in FIG. 9.

FIG. 10 is a front view of a device controller according to an exemplary embodiment of the present invention.

FIG. 10A is a side view of the device controller shown in FIG. 10.

FIG. 10B is an isometric view of the device controller shown in FIG. 10.

### DETAILED DESCRIPTION

In embodiments of the present invention, a sound system is provided, which in its most basic form has a headpiece disposed in mechanical communication with a pair of ear pieces, each ear piece in turn having both an interior speaker and an exterior speaker and means for control of sound distributed therefrom. Embodiments of the present invention allow for audio signals to be emitted through internal speakers, external speakers or both. Embodiments of the present invention are configured to connect to a phone and transmit audio input via a microphone back to the phone. Embodiments of the present invention provide collapsible earpieces configured to stack together to form a portable sound system.

The system includes a receiving means for receiving audio signals transmitted from an audio signal transmission means; volume and speaker destination control means such as miniaturized circuitry or the like; and high-quality speakers disposed in communication with both an interior surface and an exterior surface of each ear piece, so that sound can be forwarded and enjoyed by either wearers of the system (in the case of the interior speakers) and/or by those in a reasonably proximate surrounding are (in the case of the external speakers).

The sound distribution and control means can be hard wired and facilitated by electrical communication between the receiving and transmission means and the system's associated speakers, or by other means known in the art or yet to be invented, the former including currently known technologies such as wireless communication systems, Bluetooth, etc.

In various embodiments, one or more of the speakers can be unscrewed or otherwise disconnected from its usual headset mount so that the speakers can be moved around a room and controlled in a similar fashion.

In other embodiments, the headset or portions thereof collapse or release in such a manner that they can be integrally docked as part of a portable sound system such as a “boom box” or the like. In alternative embodiments, the system comprises headphones that transform into a portable stereo or other sound system such as a “boom box,” or instead a portable stereo such as a boom box that transforms into headphones.

In one specific embodiment, the system comprises a plurality of speakers, e.g., one disposed on the inside of each ear cup that focuses on the internal sound; one in each ear cup that focuses on higher frequencies; one in each ear cup that focuses on the middle frequencies; and/or one in each ear cup that focuses on low-end frequencies.

In another embodiment the external speakers comprise a plurality of speakers, e.g., one built into the outside of each ear cup; one disposed in each outer ear cup housing focusing on the high frequencies; one in each outer ear cup housing focusing on the middle frequencies; and/or one disposed in each ear cup housing focusing on low-end frequencies.

In other embodiments both (or either) of the internal speakers and external speakers may be cone type drivers, or instead a flat, paper type driver. In still other embodiments, the system comprises a built-in lithium polymer battery for powering the control means.

In one embodiment, the system further comprises a power switch that activates the battery, thereby allowing a user to switch between any of a plurality of different operational modes. In further embodiments, the system comprises a built-in LED lighting system that indicates which mode is currently in use.

In a first example mode, the power switch is in the OFF position, and the headphones work as standard headphones. A user can simply plug one end of appropriately-sized audio cables into the headphones, the other end into an audio output source, and then press play to begin sound delivery from the audio output source.

In a second example mode, the power switch is in the ON position, and activates an associated battery that illuminates two LED rings that encircle the perimeter of the outer edges of the speaker housing (or another type of suitable indicator), thereby indicating that the sound is being internally amplified (by, for example, using an IC chip).

In a third example mode, the power switch is already in the ON position, the battery is already active, and the LED lights are already illuminated. A button or other activator disposed on the outside of an ear cup is pushed (or tapped) in a predetermined sequence, thereby causing sound to be transferred from the internal speakers to the external speakers.

In other embodiments, activating this activator will also change the color of the LED lights that circle the perimeter of the outer edges of the speaker housing (or other activation indication means). In still further embodiments the color change indicates that the headphones have been transformed into a portable stereo such as a boom box by, for example, using an IC chip to implement said effect. As sound is transferred from the internal speakers to the external speakers, a module disposed in communication with the headphones controls the volume of the external speakers so as to allow for a gradual build-up in volume.

In other embodiments the lights are used as mode indicators, and safety lights while walking or biking the streets at night, as well as to provide an aesthetically appealing appearance.

In still further embodiments the system has at least two cabling options; in various embodiments one (or both) of the cables are detachable. In one embodiment, the first cable is a standard 3-pin jack that enables sound to be transmitted from an associated music source to the headphones. In another embodiment, the second cable is a 4-pin jack that enables phone capabilities. In still further embodiments this latter cable comprises an in-line microphone and volume control, which enables phone calls to be accepted; to increase or decrease volume levels; to pause sound delivery; and/or to shuffle through songs obtained from a music source.

In other embodiments the headphones include at least one audio input means on the bottom of each ear cup (in one example configuration thereby resulting in a total of two audio input holes). In various embodiments either of the aforementioned cable options can be plugged into either audio input means in order to hear sound.

If a user has two or more such headphone sets and both of them are placed into the third operational mode described above (so that sound is transmitted to the external speakers), the plurality of headphones can be connected with an audio cable (or wirelessly, etc.), and transmit received sound through all externally playing speakers, thereby increasing the “boom box” effect. The headphones can also be switched into either of the first or second operational modes described above and then joined using the same basic connection principles.

In still other embodiments the headphones have wireless and/or Bluetooth compatibility. In order to activate the wireless or Bluetooth, the headphones would typically be set in the second operational mode so that the battery is active; in one specific embodiment the LED lights would illuminate and a button or the like on the outside of an ear cup pushed or tapped or held down for a predetermined period of time. In this specific embodiment the LED lights encircling the perimeter of the ear cups flash (in some embodiments using multiple colors in a predetermined sequence), thereby indicating that the wireless or Bluetooth has been activated.

The headphones can then be used wirelessly, using either wireless technology or Bluetooth or the like, to answer phone calls and listen to music or other sound input. In order to transmit the wireless signal from the headphones to the music source, a dongle or the like can be plugged into the system; a dongle is basically a receiver that picks up wireless signals coming from the headphones. The wireless technology and Bluetooth capabilities allow the user to share their music or other audio with several headphones as described above, but now in a wireless format.

In still further embodiments, the headphones are rechargeable using a micro-USB to AC adaptor or the like, which plugs directly into a wall outlet; or micro-USB to USB or the like, which plugs directly into a computer; and/or a USB to AC adaptor, which also plugs into a wall outlet. When the headphones are charging, a LED light on one or more sides will illuminate, and when the battery is done charging the LED light(s) will change colors or shut down so that the flow of power will be cut off and battery life is efficiently preserved.

In still other embodiments, a micro-USB to multi-headed adaptor cable provides options for multiple phones, and allows a user to charge the phone battery via the headphones if desired.

In other embodiments, the headphones include a built-in DSP chip or the like that permits individual audio files or a plurality of bundled audio files to be uploaded to the headphones from a delivery source such as a web site. Each user selects files or bundles of files of their choice, and in one specific embodiment the user is able to customize the equalization settings in the headphones based on a chosen music artist, reader, producer, etc. This embodiment functions similar to a subscription model, in which users pay a predetermined fee in exchange for either limited or unlimited access to new and/or previously purchased and stored files and bundles of files.

In a further embodiment, a user plugs one end of a micro-USB into the headphones (for example, using one of two micro USB inputs), and the other end of the USB into a computer; the two devices are then able to synchronize with one another, thereby allowing for information to be passed therebetween. The same process can also be accomplished using wireless technology or using Bluetooth technology or the like.

In still further embodiments, the external speakers have a new technology built-in that the inventors currently refer to as “Bass Space,” in which the exterior portions of the external speakers rotate either clock-wise or counter clock-wise in a manner similar to an SLR lens on a camera. This functionality enables the speaker chamber to be either increased or decreased in size. By increasing the size of the speaker chamber, a louder, deeper bass and overall sound profile is achieved. By decreasing the size of the speaker chamber, the overall sound becomes less intense, but is still robust and delivers a fuller spectrum of a captured audio signal(s).

The headphones can similarly fold and collapse into a large number of desirable configurations. When folded inwards, for example, a third (or more) audio input hole is exposed that is usually hidden within a joint of the headphones that only becomes exposed during this process. This allows the headphones to be folded and placed into a protective case or personal audio system profile, while the newly exposed audio input remains easily accessible through the outside of the protective case audio system container. The case then not only protects the headphones, but also essentially becomes an “exo-boom box,” by creating a larger cavity around the headphones, thereby allowing for a more robust, deeper, amplified sound delivery profile.

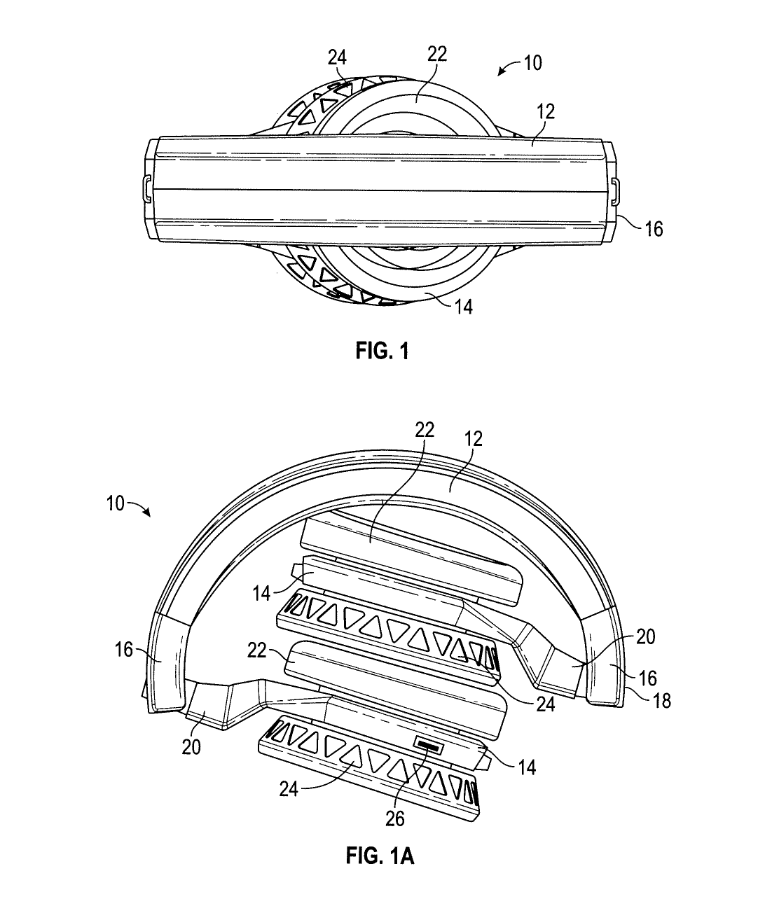

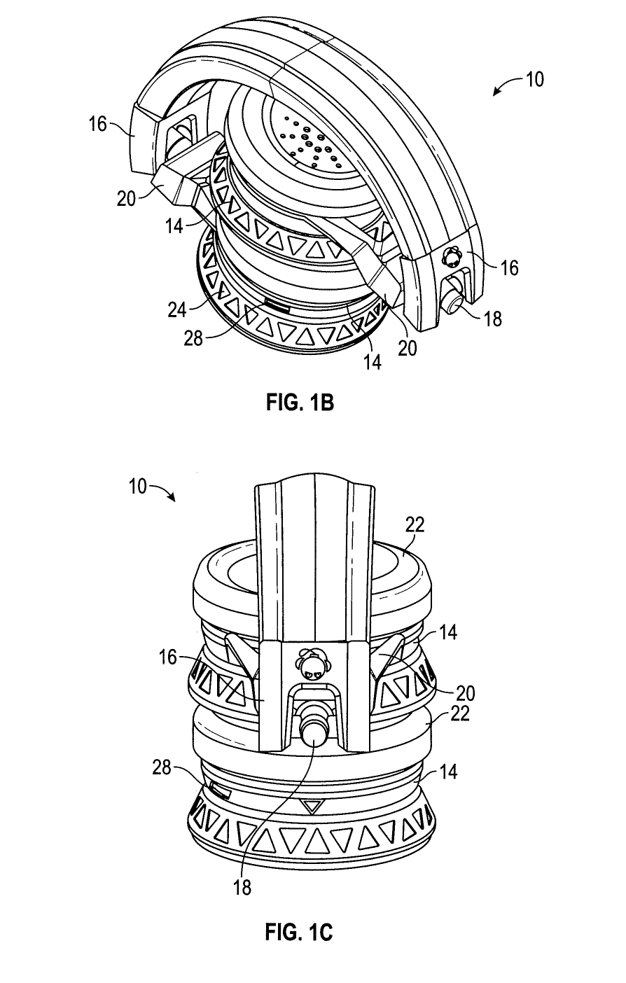

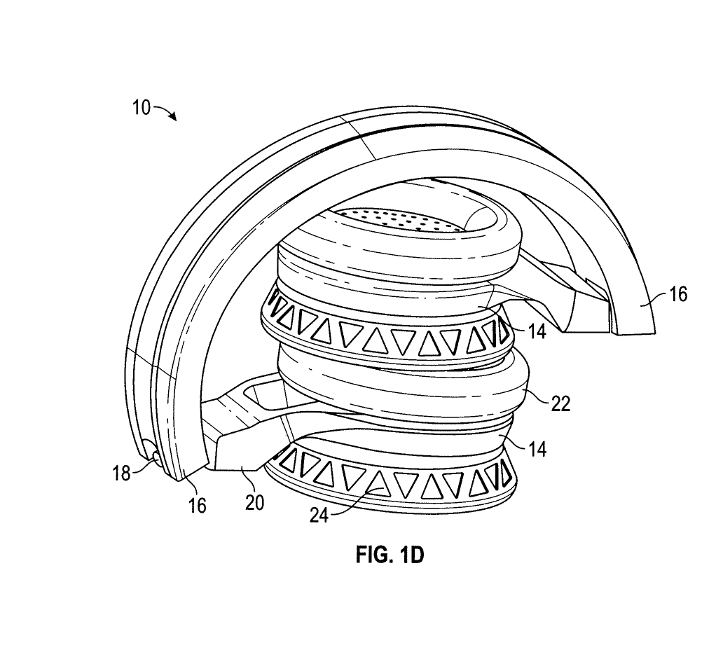

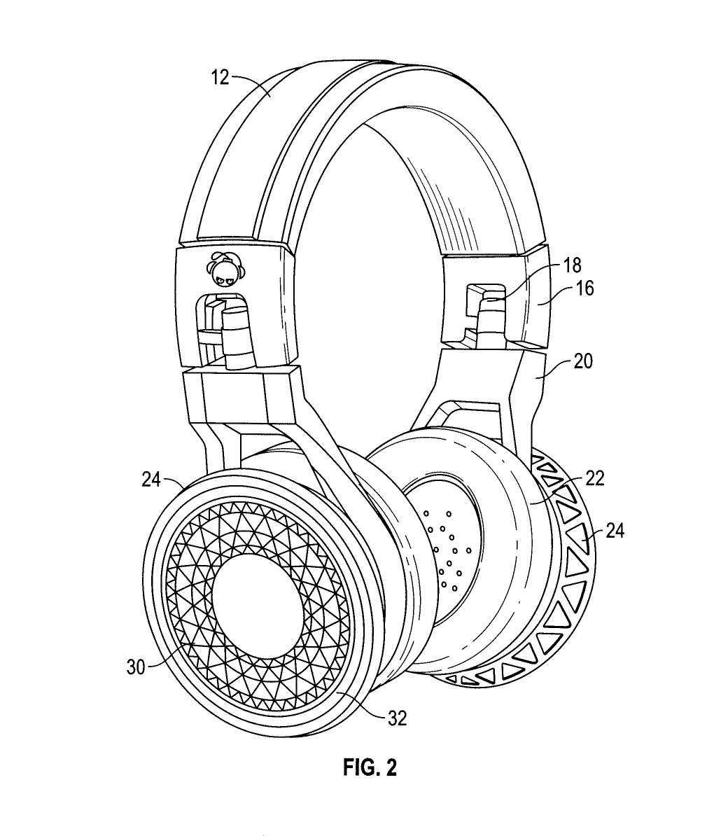

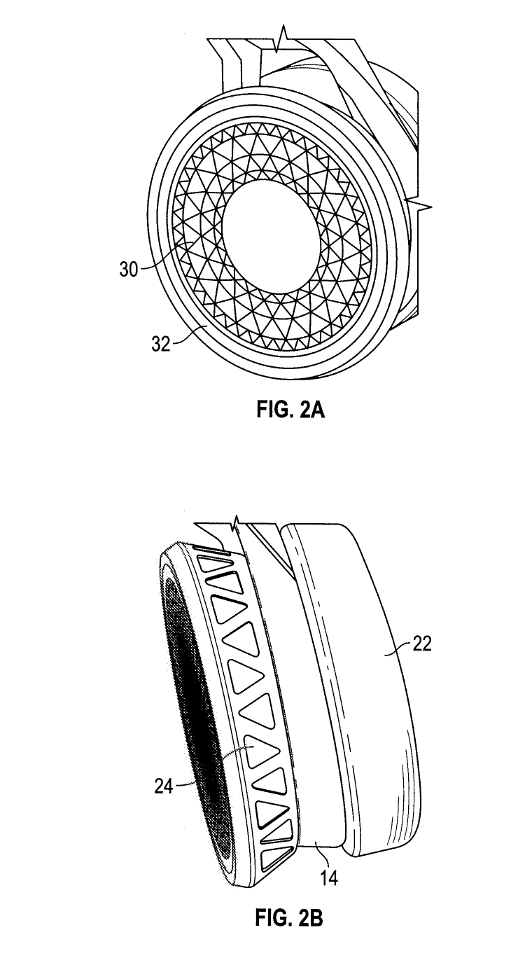

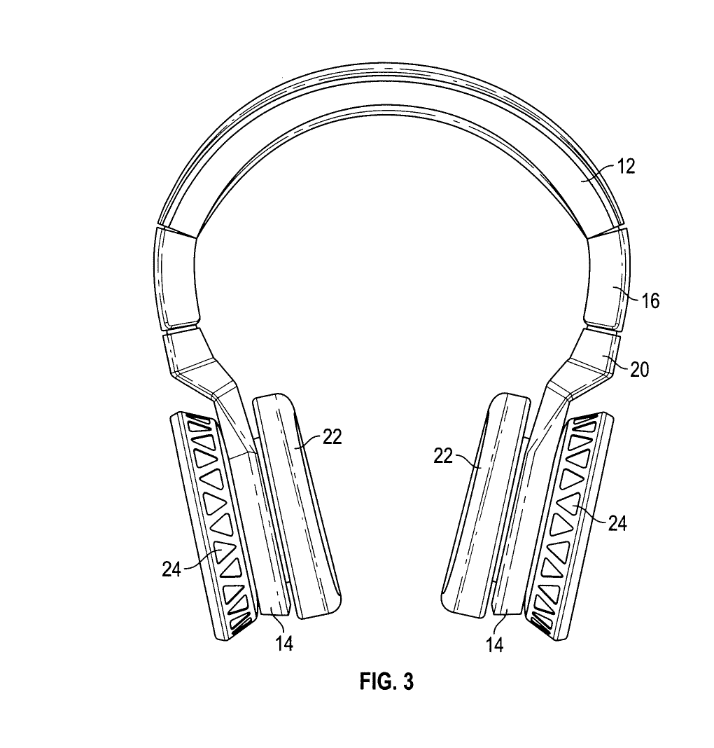

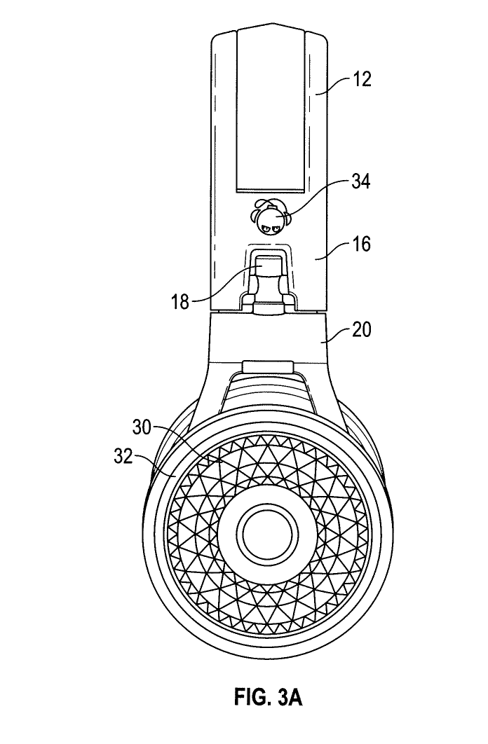

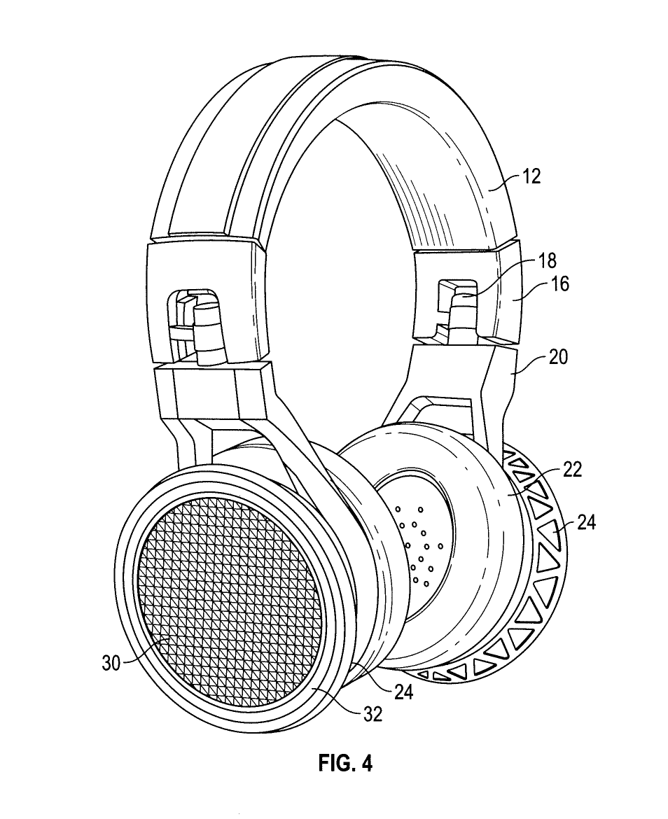

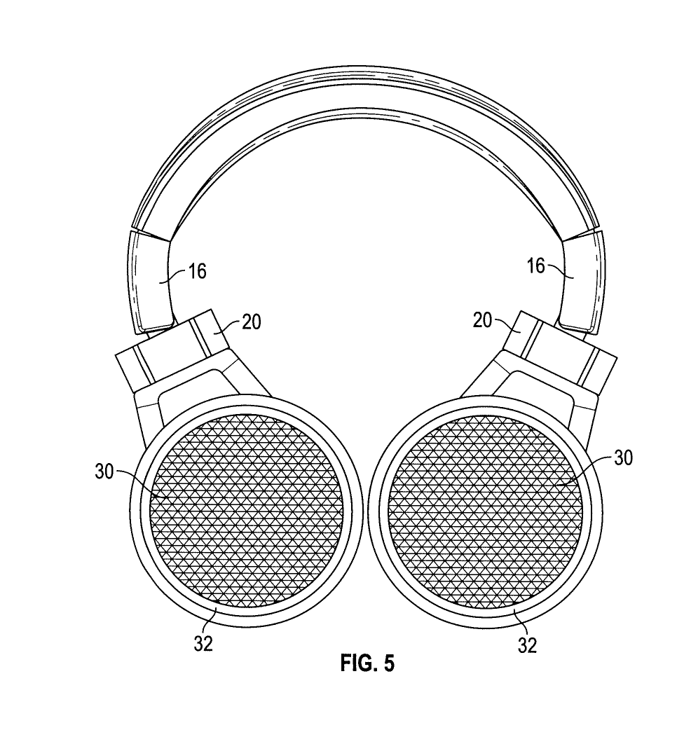

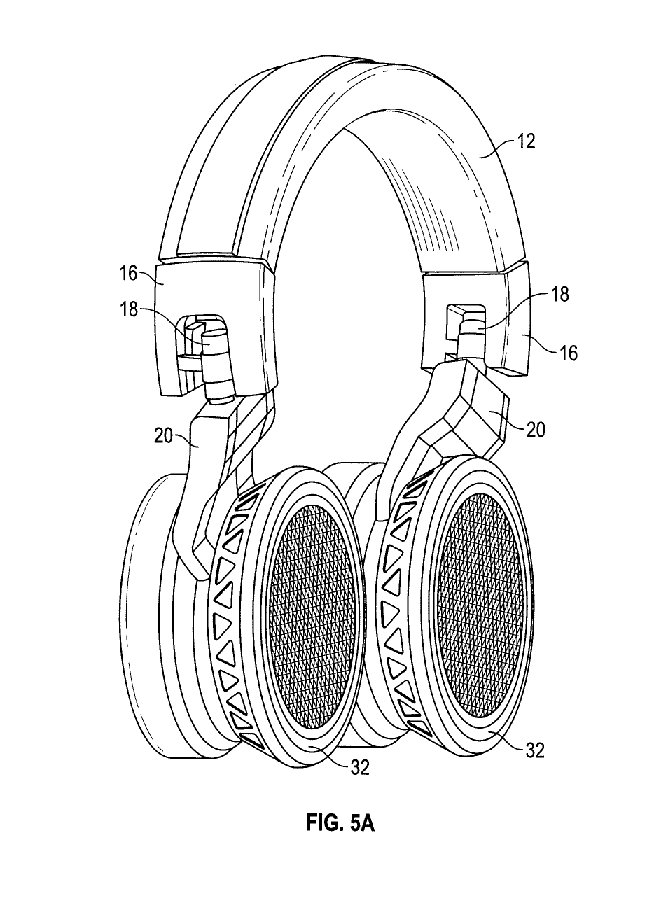

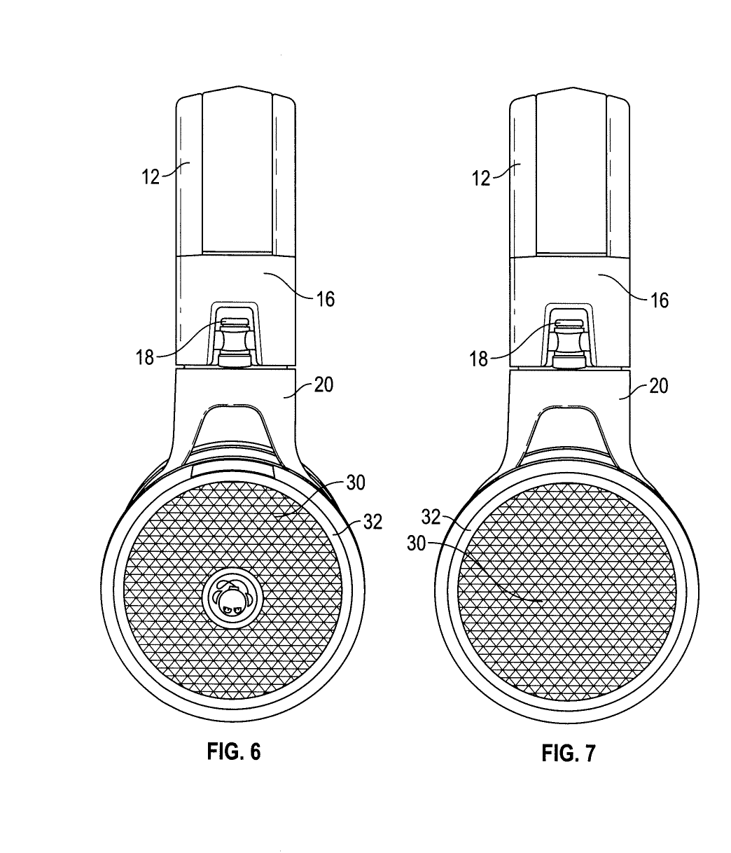

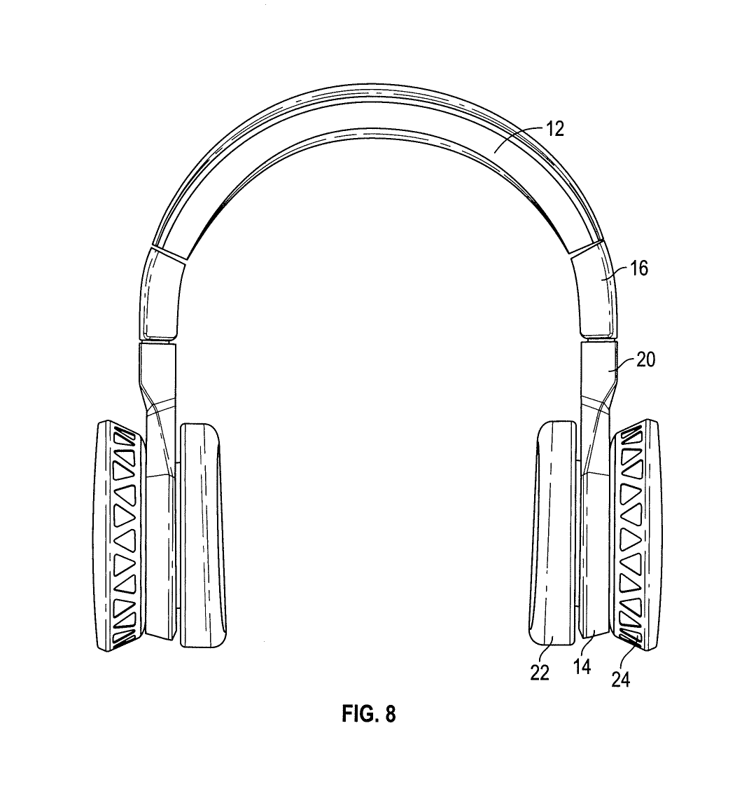

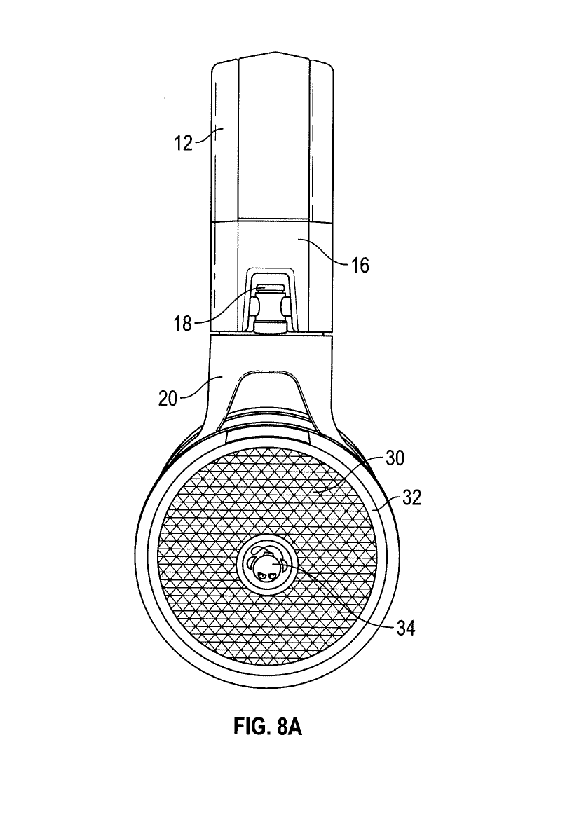

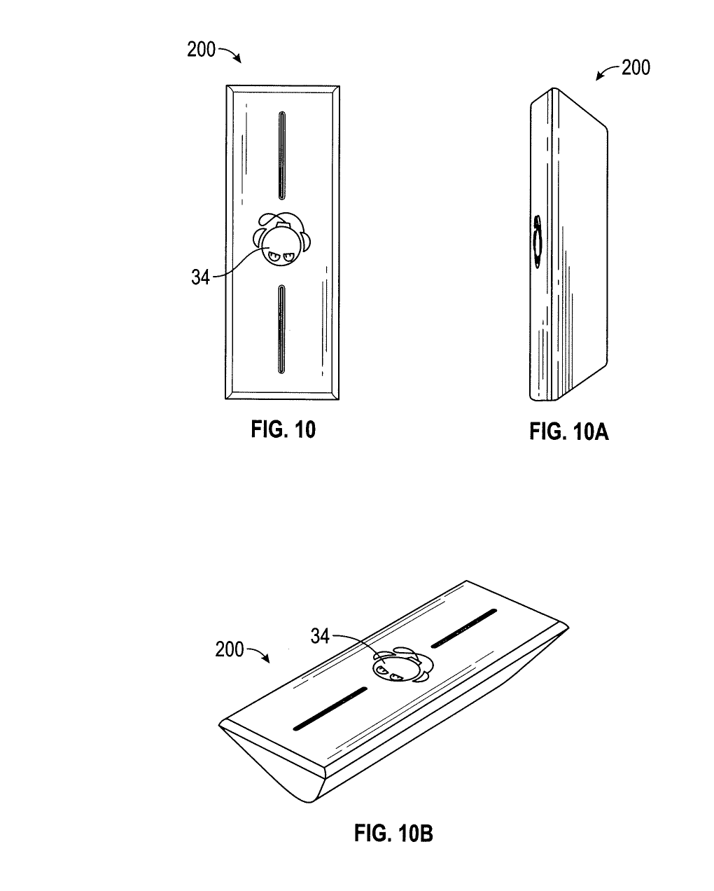

Now referring to FIGS. 1 through 10B, in exemplary embodiments of the present invention, there is provided headphones 10 having head piece 12, which is generally curved, with earpiece connectors 16 at either end of head piece 12. Earpieces 14 may be detachably connected to earpiece connectors 16 via earpiece extensions 20. Earpiece extensions 20 may have pin extensions 18 which connect to earpiece connectors 16 such that pin extensions and the connected earpieces 14 may rotate along a central axis of pin extension 18 when pen extension 18 is connected to earpiece connectors 16. In this way, earpieces 16 may be rotated such that inner ear cups 22 face each (e.g., FIGS. 3 and 3A) or such that outer speakers 24 face substantially the same direction (e.g, FIGS. 5 and 5A). The connection between earpiece extensions 20 and earpiece connectors 16 also allow the earpieces 14 to rotate inward toward each other and headpiece 12 or outward away from each other. See, e.g., FIG. 1A. Embodiments of the present invention allow for the earpieces 14 to be collapsed onto each other. See, e.g., FIGS. 1 to 1D. Accordingly, embodiments of the present invention may be stacked together forming a portable audio system.

Embodiments of the present invention may include grills 30 covering outside speakers 24, which grills 30 may be of various patterns, examples of which are provided in the Figures. Embodiments may include an LED light 32 on the outer speakers, which LED light 32 may be used to indicate if the outer speakers are on. Logos 34 or other marketing materials may be placed at various locations on headphones 10. Earpieces 14 may include one or more ports 28 which may be USB ports. Earpieces 14 may also include switch 26, which may be a power switch.

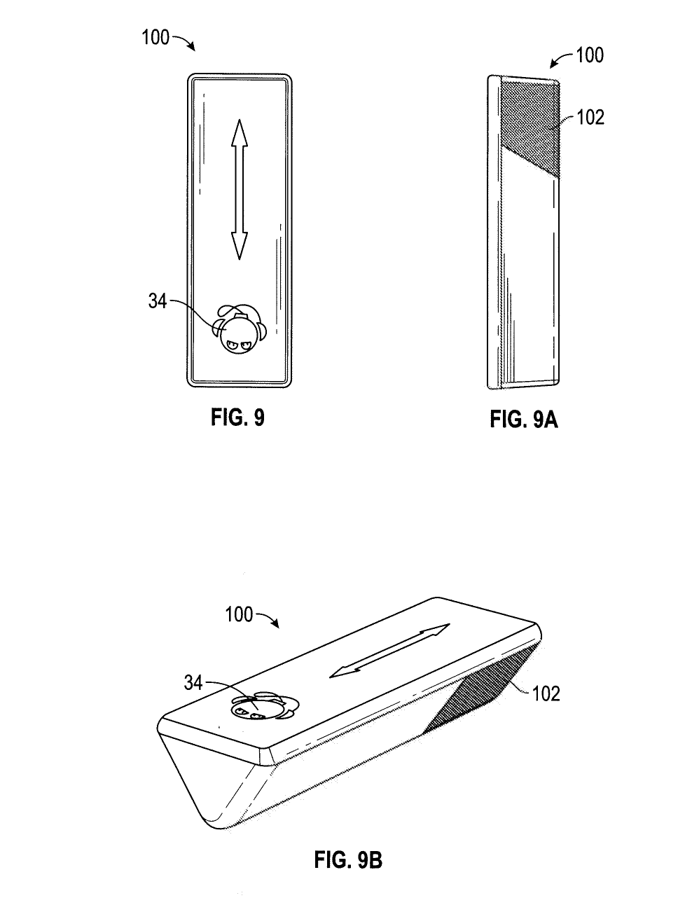

Embodiments of the present invention include phone controller 100 having a microphone 102. See, e.g., FIGS. 9 to 9B. Phone controller 100 may be directed connected to headphones 10 or it may be wirelessly connected, e.g., Bluetooth. Embodiments of the present invention include device controller 200, which may be configured to control various functions of the present invention.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from either the spirit or scope thereof.

What is claimed is:

1. An audio system, comprising:
a headpiece;
a pair of earpieces each earpiece having at least one internal speaker on one side and at least one external speaker on an opposite side;
at least one audio signal input configured to receive an audio signal; and
a sound distribution and control means;
wherein the sound distribution and control means is configured to direct transmission of the audio signal to at least one of the internal speakers and the external speakers;
wherein the earpieces are detachably connected to the headpiece; and
wherein the connection of the earpieces to the headpieces allows for the earpieces to be collapsed inward toward the headpiece and such that the earpieces can be stacked upon each other.

2. The audio system of claim 1, further comprising a power switch and a battery.

3. The audio system of claim 2, wherein the power switch activates the battery.

4. The audio system of claim 2, wherein the battery is rechargeable.

5. The audio system of claim 4, further comprising a port.

6. The audio system of claim 2, further comprising: at least one LED lighting system.

7. The audio system of claim 6, wherein the at least one LED lighting system is configured to indicate different modes of the audio system.

8. The audio system of claim 1, further comprising: an amplification means configured to amplify an audio signal to the external speakers.

9. The audio system of claim 1, further comprising: an audio input for each earpiece.

10. The audio system of claim 1, further comprising: at least one volume control.

11. The audio system of claim 1, further comprising: at least one 4-pin jack.

12. The audio system of claim 11, further comprising a phone controller.

13. The audio system of claim 5, wherein the port is a USB port.
